(19) United States
(12) Patent Application Publication
(10) Pub. No.: US 2024/0377015 A1
(43) Pub. Date: Nov. 14, 2024

(54) Fluted conforming thermal insulation and method

(71) Applicants: Jason S. Smith, Crystal Lake, IL (US); Chad H. Menster, Lake in the Hills, IL (US); Kyle A. Brady, Crystal Lake, IL (US)

(72) Inventors: Jason S. Smith, Crystal Lake, IL (US); Chad H. Menster, Lake in the Hills, IL (US); Kyle A. Brady, Crystal Lake, IL (US)

(21) Appl. No.: 18/660,132

(22) Filed: May 9, 2024

Related U.S. Application Data
(60) Provisional application No. 63/465,058, filed on May 9, 2023.

(51) Int. Cl. F16L 59/02; B32B 1/08; B32B 3/30; B32B 5/18; B32B 15/04; F16L 53/38; F16L 59/12

(52) U.S. Cl. CPC F16L 59/026; B32B 1/08; B32B 3/30; B32B 5/18; B32B 15/046; F16L 59/12; B32B 2266/0214; B32B 2597/00; F16L 53/38

(57) ABSTRACT

A substantially planar oblong panel of flexible material such as silicone foam rubber can be wrapped on a thermally sensitive fluid conduit to insulate it against unwanted thermal changes. The panel can be formed to have a plurality of voids on its inner surface. The voids can be in the form of a number of parallelly spaced apart longitudinal flutes separated by raised buttes therebetween. The elongated flutes can be substantially wedge-shaped to allow them to collapse when the panel is wrapped upon a substantially cylindrical conduit such as a pipe. The angular separation between buttes can be selected so that the flutes are substantially eliminated when the block is completely installed upon the conduit of a given diameter. The flutes allow for greater flexibility of the block during installation.

### PRIOR APPLICATIONS

This application claims the benefit of US Provisional Utility Patent Application Ser. No. 63/465,058, filed 2023 May 9, incorporated herein by reference.

### FIELD OF THE INVENTION

The instant invention relates to thermal management of fluid conduits and more particularly to insulation systems for gas supply and exhaust lines used in semiconductor fabrication, for example.

### BACKGROUND OF THE INVENTION

Many industries such as semiconductor fabrication, chemical and pharmaceutical production, medical treatment, and other various types of manufacturing, require insulated and often times heated conduit lines for fluids, including gasses, liquids, solids or semisolids in liquid suspension, phase change materials such as gallium, imperfect vacuums, and the like. For example liquid metal supply lines for use in x-ray equipment must be heated to maintain the proper temperature of the liquid metal.

The microelectronic semiconductor fabrication industry in particular involves the need for highly regulated gas transmission conduit lines leading to and from the fabrication vessels used to process semiconductor wafers. These specialized gasses are used for processing applications such as low pressure chemical vapor deposition (LPCVD), metal organic chemical vapor deposition (MOCVD), high density chemical vapor deposition (HDCVD), atomic layer deposition (ALD), controlled sublimation, and plasma etch for example.

Generally speaking, preprocess fluid supply and postprocess exhaust conduit lines or more often merely called “lines” used in semiconductor fabrication can include long stretches of conduit, often dozens of meters in length, in which the carried fluid must be maintained within a narrow range of temperatures. Exhaust lines which carry gasses away from the process chamber can also be referred to as fore lines, or pump lines.

In semiconductor manufacturing, gas supply and exhaust lines are typically made from stainless steel. Supply lines can typically have a diameter of between about 0.25 inch (6.3 mm) and 0.75 inch (19 mm), while exhaust lines can typically range from between about 1.5 inch (38 mm) and 6.0 inches (152 mm). For many medical device applications, fluid-carrying tubes can have outer diameters smaller than 2 mm. Even though some supply line tubes may have an inner diameter of less than about 2 cm, the outer profile to be accommodated by the insulation can be much larger. This can be due to the thickness of heater structures residing on the outer surface of the tubes.

As stated above, the gasses delivered to and removed from the semiconductor wafer fabrication reaction chamber often must be kept within a narrow range of temperatures. Target temperatures can typically between about 70° C. and 250° C., in order primarily to prevent condensation and sublimation of materials in the exhaust lines. In supply lines, condensation or sublimation can cause defects in semiconductor devices, reducing production yields and increasing the need for more frequent and/or difficult costly maintenance. In exhaust lines it can cause difficulties in processes for reuse or disposal of the fluids.

Heating the transmission lines to such temperatures requires the use of heaters which need to be insulated from the surrounding environment for temperature control and safety purposes. The heaters typically operate around the clock. Control of the temperature of the lines is usually to within +/−10° C. of a target temperature.

The evolution of wafer fabrication processes appear to likely require even higher temperatures and stricter temperature tolerances. Thus, such gas supply and exhaust lines benefit from insulating structures which are often applied along the conduit. Any such insulation needs to somehow accommodate the requirements detailed above.

Prior attempts to provide fluid conduit insulation include devices such as those disclosed in Hauschulz et al., U.S. Pat. No. 5,714,738, incorporated herein by reference, in combination with heaters. The structure can include matable preformed semi-cylindrical blocks of insulation that have been precisely dimensioned to intimately contact and enclose the conduit. This requires a fine degree of manufacturing tolerance and specificity to the shape and dimensioning of the myriad sizes of conduit.

Alternately, resiliently flexible material insulation such as silicone foam rubber has been used to cover the conduit and heater structures. In this approach a thick panel in the form of a substantially uniform quadrangular block of the material is wrapped around the conduit and secured in place by outer straps or an enwrapping cover. The bending of the thick panel around the conduit naturally causes greater compression of the material radially nearer to the conduit. In this way, the material closer to the conduit becomes denser and less able to efficiently handle its insulating duties thus reducing the insulating efficiency of the installed panel, often leading to bulkier insulation.

Further, wrapping a uniform block of resilient insulating material can be a labor-intensive process that require a high level of skill from the installing technician. Installation can be problematic due to the resiliency and thickness of the panel. Significant bending forces may be required to intimately enwrap the material around the conduit. This can be especially difficult for technicians installing the insulation on long stretches of conduit which can be several if not dozens of meters or more in length. Often times installation must be installed manually in cramped conditions making uniform application of the insulation quite difficult. For insulation containing heater elements, accurate and uniform installation is even more critical.

Prior insulating devices often required complex molds which can require significant resources in time and money. Both complex 3d printed molds and machined molds can have size restrictions, and require significant time from order to insulator completion.

The instant invention results from efforts to provide an improved fluid conduit insulation system which addresses one or more of the above problems.

### SUMMARY

The primary and secondary objects of the invention are to provide an improved fluid conduit insulation system. These and other objects are achieved by providing a specialized panel of insulation including voids formed into radially inward portions of the panel.

In some embodiments there is provided a device for insulating a fluid conduit having a substantially cylindrical outer wall section of a given radius, said device comprises: a panel of flexible, resilient, insulating material; said panel comprises: a top surface; a bottom surface; said panel being elongated between a front edge and a back edge along an axis; and, a plurality of voids extending into said top surface; wherein each of said voids extends between said front edge and said back edge.

In some embodiments said voids comprise: laterally spaced apart flutes formed into said top surface, thereby forming a number of upwardly extending buttes spaced apart by a spacing.

In some embodiments each of said flutes extends substantially linearly between said front edge and said back edge.

In some embodiments said number of upwardly extending buttes is an integer from 3 to 250.

In some embodiments the device further comprises a gap between an adjacent pair of said buttes, wherein said gap is between 0% and 70% of a cross-sectional width a first one of said adjacent pair of said buttes.

In some embodiments said flutes are substantially parallelly spaced apart and said spacing is substantially uniform.

In some embodiments each of said flutes is substantially wedge-shaped and oriented so that a widened part exists along said top surface.

In some embodiments each of said flutes has a substantially uniform cross-section between said front and back edges.

In some embodiments each of said buttes has a substantially trapezoidal cross-section having a substantially symmetrical pair of laterally angled, substantially planar flanks.

In some embodiments an adjacent pair of said buttes provide a pair of opposed flanks bordering one of said flutes; and wherein said flanks form a first angle.

In some embodiments said number of buttes equals 360 divided by said first angle in degrees.

In some embodiments a first one of said buttes comprises: an upper surface section having a substantially semi-cylindrical shape extending along an angular arc of not more than said first angle.

In some embodiments said device further comprises: a fluid conduit having a substantially cylindrical outer surface section of a given radius; wherein said arcuate upper surface section has a preformed radius commensurate with said given radius.

In some embodiments said panel further comprises: a pair of spaced apart side edges; and, a first slit extending medially from a first one of said side edges.

In some embodiments said slit is substantially V-shaped when viewed from above.

In some embodiments said the top surface can be formed to have a number longitudinally spaced apart grooves oriented at an angle to said flutes, wherein said grooves are longitudinally spaced apart by a second spacing.

In some embodiments said grooves form an angle with said flutes of between 10 and 150 degrees.

In some embodiments said angle is at least 10 degrees.

In some embodiments said angle is substantially 90 degrees resulting in said grooves being substantially orthogonal to said flutes.

In some embodiments each of said buttes is crenellated to have an array of substantially truncated pyramids.

In some embodiments said device further comprises at least one heater element connected to said panel.

In some embodiments said flexible, resilient, insulating material is selected from the group consisting of: silicone foam rubber; silicone gum rubber; extruded silicone; extruded silicone foam; moldable foam materials; moldable insulative materials; and, fiberglass.

In some embodiments said device further comprises a layer of interface material formed on a section of said top surface.

In some embodiments said layer of interface material has a higher heat tolerance than said insulating material.

In some embodiments said layer of interface material comprises a heater sleeve.

In some embodiments said flexible, resilient, insulating material cannot withstand temperatures exceeding 300° C.

In some embodiments said flexible, resilient, insulating material has a density of between about 200 kg/m3 and about 280 kg/m3.

In some embodiments said panel further comprises: a plurality of leaves; wherein each of said leaves is shaped and dimensioned to intimately wrap upon a geometrically simplified component of a complexly shaped fluid carrying structure.

In some embodiments each of said plurality of leaves has a common bending axis.

In some embodiments said voids form a structure for reducing a bending moment substantially perpendicular to said axis.

In some embodiments said device further comprises: a backing sheet made from a pliable material; and, a bonding layer securing each of said buttes to said backing sheet.

In some embodiments said backing sheet comprises: a series of rows joined by hinges.

In some embodiments said device further comprises: a blanket made from a durable, pliable sheet material secured to said bottom surface of said panel; a retaining structure secured to said blanket; whereby said retaining structure retains said panel in an enwrapped configuration about said conduit.

In some embodiments said retaining structure comprises: a plurality of belts slidingly mounted to said blanket; and, a plurality of fasteners for securing said belts in a fixed circumference.

In some embodiments there is provided a method for a insulating a substantially cylindrical outer wall of a conduit carrying a heated fluid, said method comprises: selecting a substantially quadrangular oblong panel of flexible, resilient, insulating material having a plural number of parallelly spaced apart flutes extending into a top surface, thereby forming a number of spaced apart buttes; orienting said panel so that a capital surface of a first one of said buttes bears against an angular portion said outer wall; and, bending a remainder of said buttes into contact with said outer surface, thereby collapsing said flutes.

In some embodiments said bending comprises: applying a force of no more than 90% of the force required to bend a solid quadrangular panel of the same material.

In some embodiments said bending comprises: applying a force of between about 30% and 90% of the force required to bend a solid quadrangular panel of the same material.

In some embodiments said selecting comprises: adjusting said plural number and a spacing of said buttes according an outer diameter of said conduit.

In some embodiments said method further comprises: heating said conduit to at least 200° C.

In some embodiments said selecting comprises: choosing said panel to have a maximum thickness of at least 0.3175 cm; and, forming a heating element onto a first one of said buttes.

In some embodiments there is provided the combination of a semiconductor fabrication vessel gas conduit having a heatable, substantially cylindrical outer wall, and a conduit enwrapping insulator having an inner surface shaped and dimensioned to intimately contact said outer wall, wherein said insulator comprises: a substantially quadrangular oblong panel of flexible, resilient, insulating material; wherein said panel comprises: a top surface; a bottom surface; said panel being elongated between a front edge and a back edge along an axis; and, a structure for reducing a bending moment substantially perpendicular to said axis, wherein said structure comprises: a plurality of laterally spaced apart flutes formed into said top surface, thereby forming a number of buttes spaced apart by a spacing.

The content of the original claims is incorporated herein by reference as summarizing features in one or more exemplary embodiments.

### BRIEF DESCRIPTION OF THE DRAWINGS

FIG. 1 is a diagrammatical perspective illustration of a panel of resiliently flexible insulation according to an exemplary embodiment of the invention.

FIG. 2 is a diagrammatical partial cross-section end view of the panel of FIG. 1 taken along line 2-2.

FIG. 3 is a diagrammatical cross-section end view of the panel of FIG. 1 installed upon a cylindrical conduit.

FIG. 4 is a diagrammatical partial cross-section end view of an insulating panel detailing various dimensional characteristics.

FIG. 5 is a diagrammatical cross-section end view of the panel of FIG. 1 being installed upon a cylindrical conduit.

FIG. 6 is a diagrammatical cross-section end view of the panel of FIG. 5 after a bending force is applied.

FIG. 7 is a diagrammatical cross-section end view of the panel of FIG. 1 having a heating sleeve attached thereto and being installed upon a cylindrical conduit.

FIG. 8 is a diagrammatical perspective illustration of the panel of FIG. 1 mounted upon a cylindrical conduit wrapped with a helical heater sleeve.

FIG. 9 is a diagrammatical perspective illustration of a panel of resiliently flexible insulation having a pliable outer blanket according to an alternate exemplary embodiment of the invention.

FIG. 10 is a diagrammatical partial cross-section end view of the panel of FIG. 9 taken along line 10-10.

FIG. 11 is a diagrammatical partial cross-section end view of a panel of resiliently flexible insulation having a pliable outer blanket including a pit formed into the blanket at the bottom tip of a flute.

FIG. 12 is a diagrammatical perspective illustration of a panel of resiliently flexible insulation having interconnected leaves adapted to intimately wrap around complex fluid carrying structures according to an alternate exemplary embodiment of the invention.

FIG. 13 is a diagrammatical perspective illustration of a panel of resiliently flexible insulation having a pliable outer blanket with lateral slits to accommodate a curved conduit.

FIG. 14 is a diagrammatical perspective illustration of the panel of FIG. 13 installed upon a curved conduit.

FIG. 15 is a diagrammatical perspective illustration of a panel of resiliently flexible insulation having upper surface flutes and grooves to form an array of spaced apart truncated pyramids.

FIG. 16 is a diagrammatical perspective illustration of the panel of FIG. 15 installed upon a curved conduit.

FIG. 17 is a flow chart diagram of a process for installing a panel of insulation to a fluid carrying structure according to an exemplary embodiment of the invention.

### DESCRIPTION OF THE EXEMPLARY EMBODIMENTS

In this specification, the references to top, bottom, upward, downward, upper, lower, vertical, horizontal, sideways, lateral, back, front, proximal, distal, etc. can be used to provide a clear frame of reference for the various structures with respect to other structures typically while the panel is laid flat, and not treated as absolutes when the frame of reference is changed, or when the device is inverted, bent, folded, or when it is installed upon a conduit.

If used in this specification, the term “substantially” can be used because manufacturing imprecision and inaccuracies can lead to non-symmetricity and other inexactitudes in the shape, dimensioning and orientation of various structures. Further, use of “substantially” in connection with certain geometrical shapes, such as “triangular”, “wedge-shaped” and “cylindrical”, and orientations, such as “parallel” and “perpendicular”, can be given as a guide to generally describe the function of various structures, and to allow for slight departures from exact mathematical geometrical shapes and orientations, while providing adequately similar function. Those skilled in the art will readily appreciate the degree to which a departure can be made from the mathematically exact geometrical references.

If used in this specification, the word “axial” is meant to refer to directions, movement, or forces acting substantially parallel with or along a respective axis, and not to refer to rotational nor radial nor angular directions, movement or forces, nor torsional forces.

In this specification the units “millimeter” or “millimeters” can be abbreviated “mm”, “centimeter” or “centimeters” can be abbreviated “cm”, and “milligram” or “milligrams” can be abbreviated “mg”. Units of temperature such as “degrees centigrade” can be abbreviated “° C.”.

The following description will describe the exemplary embodiments primarily in connection with semiconductor fabrication equipment. However, those skilled in the art of fluid temperature regulation will readily appreciate the applicability of the embodiments to chemical, pharmaceutical production, medical treatment, and other various types of manufacturing, that require insulated and often times heated conduit lines for fluids, including gasses, liquids, solids or semisolids in liquid suspension, phase change materials such as gallium, imperfect vacuums, and the like.

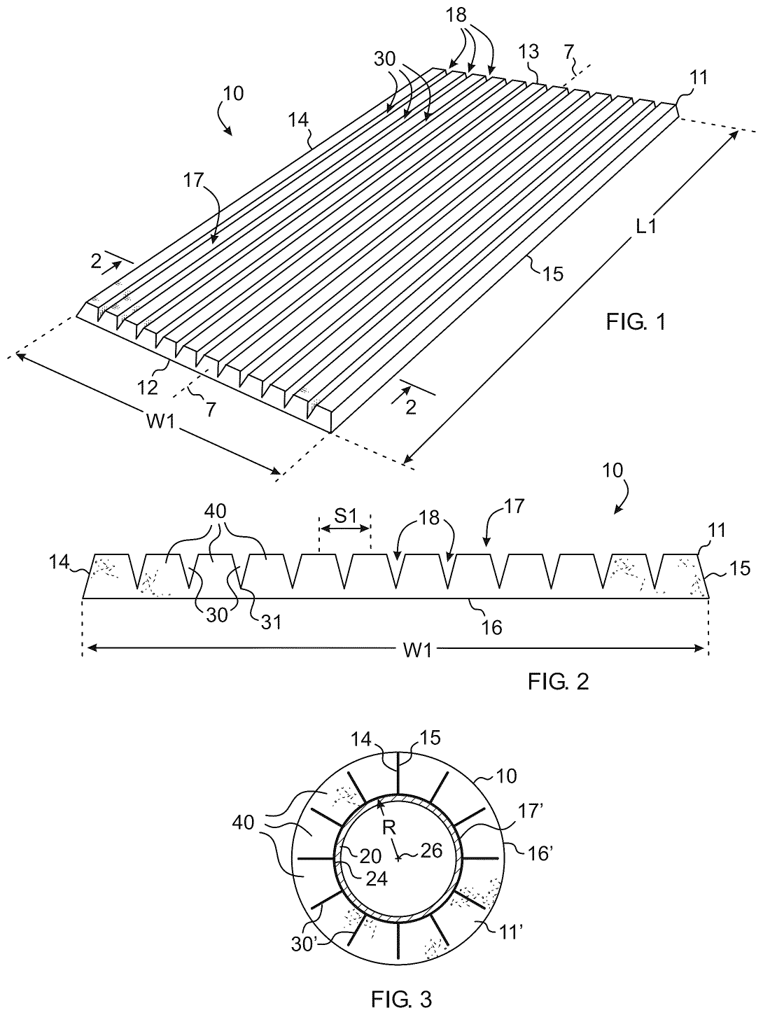

Referring now to the drawing, there is illustrated in FIGS. 1-3 an insulator device 10 used to insulate a typically stainless steel transmission line, pipe, or fluid conduit 20 which carries a fluid such as a heated gas to or from a microelectronic semiconductor reaction chamber. The device can include a panel 11 made of a flexible, resilient, insulating material such as silicone foam rubber such as 3-8209 and 3-8235 brand silicone foam commercially available from Dow Corning of Midland, Michigan, or RTF7000 brand foam commercially available from Momentive of Columbus, Ohio. The foam can be a closed cell-type foam for greater insulation and for most applications can have a density of between about 200 kilograms per cubic meter (kg/m³) (12.5 pounds per cubic foot (lbs/ft³)) and about 280 kg/m³ (17.5 lbs/ft³).

This type of silicone foam rubber can also be characterized by its temperature rating which for most applications will be no greater than 200° C. However, it should be noted that the device can be readily adapted for high temperature applications using the technology described in Smith, et al. U.S. Pat. No. 9,578,689, incorporated herein by reference. The above type of silicone foam rubber material can also be characterized by its durometer which can be between about 45 and about 50 on a Shore OO scale.

The panel 11 can have a generally, substantially quadrangular shape having a front edge 12 and a substantially parallel back edge 13 separated by a length L1 along an installation axis 7, and substantially parallel lateral side edges 14,15 separated by a width W1. The edges can surround a substantially planar bottom surface 16 and an opposite top surface 17 described in greater detail below. The top surface can have a number of voids 18 extending from the top surface toward the bottom surface. The voids can be formed in this embodiment by a number of laterally spaced apart, longitudinally elongated flutes 30. The voids form a structure for reducing a bending moment required to deflect the panel. In other words, the structure can reduce the stiffness of the panel to vertical forces applied lateral to the elongation axis.

In this embodiment the voids 18 can be formed into the top surface 17 of the panel 11 by eleven substantially wedge-shaped, longitudinally elongated reliefs, troughs or flutes 30 each having their pointed ends 31 oriented directly downwardly toward the bottom surface 16. The flutes can have a substantially uniform, V-shaped cross-section and be substantially equidistantly laterally spaced apart by a spacing S1 to form twelve longitudinally elongated, substantially uniform, similarly spaced apart buttes 40 therebetween. This embodiment further shows that the flutes can extend substantially linearly between the front edge 12 and the back edge 13 of the panel. Alternately, the flutes can extend in a non-linear manner.

Alternately, the spacing and even shape of the buttes can be adjusted to be non-uniform so that the insulator more closely conforms to a complexly shaped conduit. For example, for a non-cylindrical conduit, some of the buttes can have greater widths corresponding to flatter zones of the conduit surface, and narrower widths for zones of greater curvature. Further, the number of buttes can be selected by the insulator designer based on the diameter of the conduit and thickness of the sheet. Depending on these and other parameters the number of buttes can be an integer from 3 to 250.

As shown primarily in FIG. 3, the panel 11′ can be laterally bent about its bending axis or installation axis 7 into a substantially cylindrical shape as it is installed upon the substantially cylindrical outer wall section 24 of the conduit 20 of a given radius R as measured from the conduit central axis 26. The now curved top surface of the panel intimately contacts and conforms to the outer wall section to form an inner contact surface 17′, while the bottom surface of the panel forms a substantially cylindrical outer surface 16′ of the installed panel. The flutes have collapsed to form radial cuts 30′ extending longitudinally and radially from the inner curved contact surface.

In this way, the separation of the buttes can be substantially eliminated when the panel is completely installed upon the conduit. The flutes allow for greater flexibility of the panel during installation. It shall be noted that the width of the panel in its flattened state can be selected so that it matches the intended diameter of the panel when it is installed upon the conduit where the lateral edges 14,15 can abut one another.

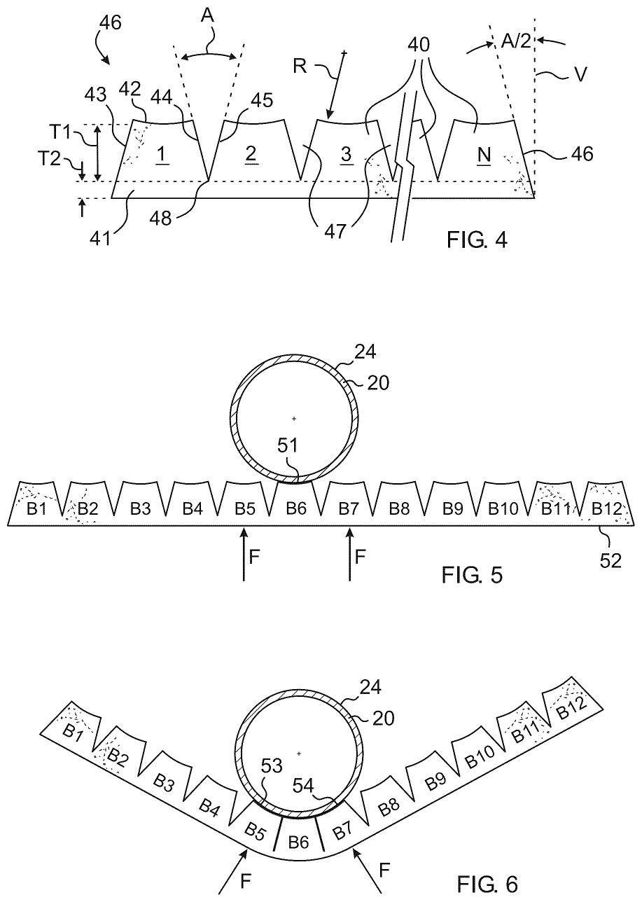

As shown in FIG. 4, a cross-sectional shape of the panel 46 can be characterized a number N of laterally spaced apart buttes 40 separated by N−1 flutes 47. The buttes can extend upwardly a height T1 from a bottom backing layer 41 having a substantially uniform thickness T2. Each butte can have a substantially trapezoidal cross-sectional shape having a top capital 42 forming a portion of the top surface of the insulation panel. The capital can be flat or optionally be formed as shown to have a semi-cylindrical shape having a radius R commensurate with the outer radius of the conduit to which the panel is intended to be installed. The resiliency of the insulator material can allow the capital surface to conform to the outer surface of the conduit. A pair of substantially planar angled flanks 43,44 can straddle the capital. Each flank can extend from an edge of the capital to a substantially V-shaped floor 48 of a flute.

The flanks 44,45 between an adjacent pair of buttes can form a substantially V-shaped flute. The substantially planar flanks opposing one another can thus be angularly spaced apart by an angle A. The flanks 43,46 forming the lateral side edges of the insulating panel can be similarly angled by an angle A/2 measured from the vertical V so that when the panel is installed the side edges meet up to abut one another without significant compression or to form just another cut.

Referring now to FIGS. 5-6, the panel 52 can have twelve laterally adjacent buttes sequentially numbered B1 to B12. The panel can be installed onto the substantially cylindrical outer surface 24 of a conduit 20 by holding the conduit stationary and contacting the capital 51 of a medial butte such as B6 against an angular portion of the outer surface. Applying a force F to the center of laterally adjacent buttes B5 and B7, the panel is caused to bend about the conduit as shown in FIG. 6 where the capitals 53,54 of the adjacent buttes contact the outer surface of the conduit. A force of similar magnitude can then be applied to the next adjacent buttes B4 and B8 to similarly cause the panel to bend toward the conduit. This process can be continued until the entire panel enwraps the conduit as shown in FIG. 3. Those skilled in the art will readily appreciate how this installation process can be adapted to panels having different numbers of buttes.

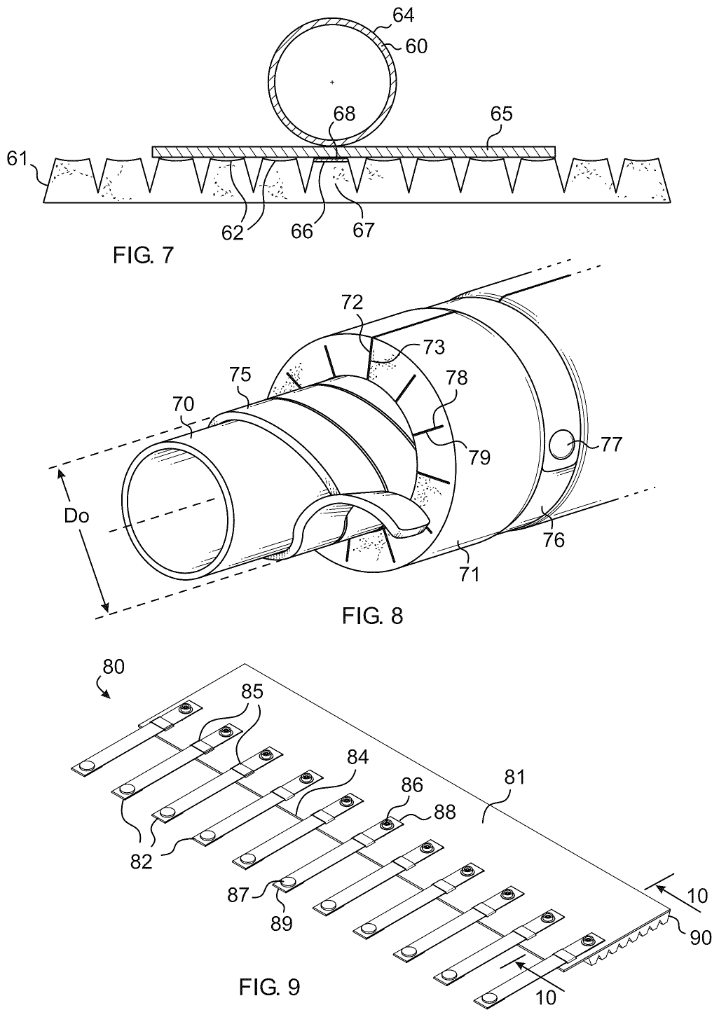

As shown in FIG. 7 the capital surfaces 62 of a panel 61 need not directly contact the outer surface 64 of the conduit 60. Instead, the capital surfaces can contact a layer of interfacing material such as a pliable heating sleeve 65 secured to the capital 66 of a medial butte 67 by a layer of flexible adhesive 68. The shape of the medial butte and its straddling flutes can be adjusted to accommodate connection to the sleeve. As the insulating panel is wrapped upon the conduit, the heating sleeve contacts and enwraps the conduit while the panel enwraps the sleeve.

FIG. 8 shows that a heating sleeve 75, formed by a helical band, can be separately wrapped upon a substantially cylindrical conduit 70. An insulating panel 71 can then be installed radially outward and upon the cylindrical outer surface of the sleeve in a manner similar to the installation upon a conduit without a sleeve. It shall be noted that the width of the panel in its flattened state can be selected so that it matches the intended diameter of the panel when it is installed upon the conduit including an installed heating sleeve, where the lateral edges 72,73 can abut one another.

The substantially cylindrical shape of the installed panel 71 can be maintained by a number of retaining structures such as belts 76 including snaps 77 as shown, outer wrapping layers, velcro, latches, glue, or other fastening mechanisms known in the art. In this way the installed panel can provide insulation to the conduit along the outer wall section of a given length while reducing internal compression of the panel material and thus maintaining improved insulation efficiency.

It shall be understood that the spacing or amount of compression between the flanks 78,79 of adjacent buttes can be made adjustable, depending on the requirements of the insulation in the particular application. In other words, the amount of compression experienced by the insulating panel when it is installed upon the conduit can be adjustable and depend upon the selected geometry of panel. For example the angle between the flanks in the flattened state can be select so that a gap exists between the flanks after the panel is installed. Alternately, the angle can be selected to provide contact between the flanks, and even compression at the flanks.

FIG. 9 shows an insulator device 80 can have an outer blanket 81 made from a durable pliable sheet material such as fiberglass which can retain the panel 90 in an enwrapping configuration, and provide a durable outer cover for the insulator while it is installed upon a conduit. A retaining structure such as a number of retaining straps such as belts 82 can be mounted to the outer surface of the blanket. The belts can be longitudinally spaced apart along one lateral side 84 of the blanket. Each belt can be slidingly secured to the blanket by a loop 85 bonded to the blanket. Each belt can have a pair of cooperative snap fasteners 86,87 located near the opposite ends 88,89 to secure the belt to itself and form a fixed circumference for retaining the installed panel. Other fastening means such as adjustable slides, cam buckles, zip ties, hose clamps, or other known strapping hardware can be used in lieu of snaps and/or belts, and secured by the loops to the blanket. In this way the various types of a retaining structures can be carried by the insulator panel and hold the installed insulator panel in its curved configuration surrounding the conduit.

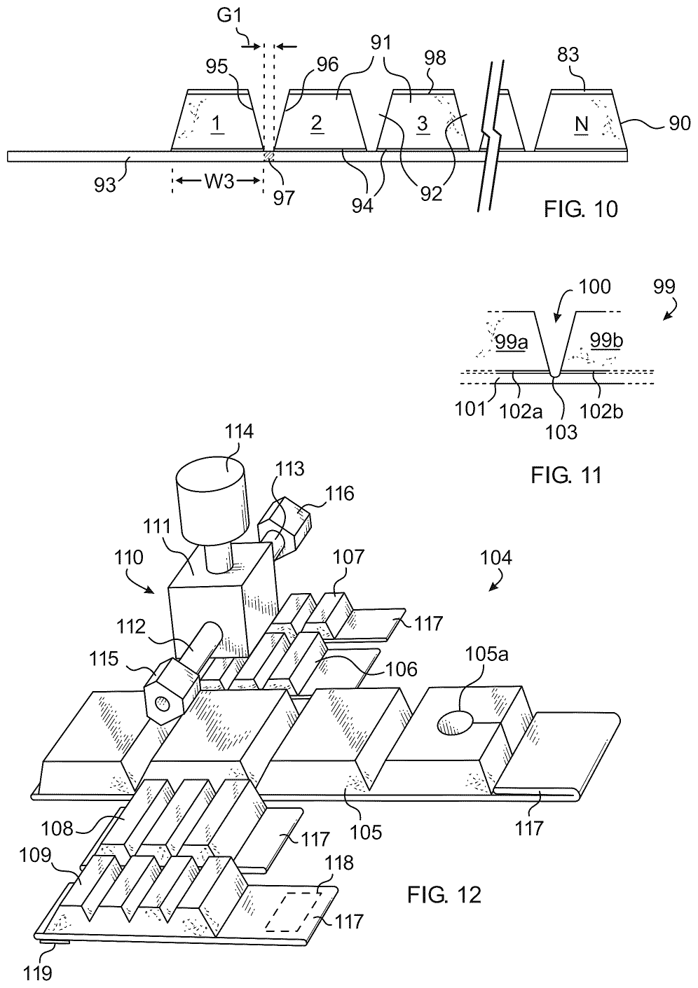

FIG. 10 shows an alternate embodiment of a panel 90, in which its cross-sectional shape can be characterized by a number N of laterally spaced apart buttes 91 separated by N−1 flutes 92. The buttes can be secured to a backing sheet or outer blanket 93 made from pliable sheet material such as fiberglass using a bonding layer of adhesive 94 such as glue. The buttes can be laterally spaced apart from one another a gap G1 between the flanks 95,96 of adjacent buttes to allow the blanket to provide a webbing zone 97 in the gap between buttes that pliably allows the flute to collapse when the panel is bent during installation. In this way the webbing zones between the buttes provides hinges between a series of spaced apart rows of the blanket bonded to the buttes. The flute can thus have a substantial V-shaped cross-section but with a flattened lower tip rather than a pointed lower tip. For example the gap between an adjacent pair of these buttes can be between about 0% and 70% of a cross-sectional width W3 of a first one the buttes.

This embodiment also shows that a layer of interface material 83 which can withstand a higher temperature can be formed on a section of the top surface of the panel 90 such as the crowning surface 98 of the buttes. In this way, the remainder of the buttes can be made with a material having a lower temperature rating but which may be preferable due to its other properties, such as being more insulating, more flexible, or less expensive.

FIG. 11 shows an alternate embodiment of a panel 99 of resiliently flexible insulation having a pair of adjacent buttes 99a,99b separated by a flute 100. The buttes can be bonded to a pliable outer blanket 101 by layers of adhesive 102a, 102b. A pit 103 can be formed into the upwardly facing surface of the blanket forming the bottom of the flute. The pit allows the blanket to be more flexible below the flute, reducing the force required to bend the panel into shape around the conduit during installation. In this way, the flute can have a substantially V-shaped cross-section but with a rounded lower tip.

FIG. 12 shows that an insulator panel 104 can be formed into a complex set of interconnected leaves 105, 106, 107, 108, 109 where each of the leaves can include spaced apart flutes for allowing the panel to conveniently fold about and intimately enwrap the various parts of a complex fluid carrying structure such as a valve 110. In this embodiment the leaves have a common bending axis provided by the flutes being substantially parallel to one another. The valve can include a substantially quadrangular housing 111 into which connects an inlet conduit 112, an outlet conduit 113, and an exposed valve stem 114. The inlet and outlet conduits can also include radially widened fittings 115, 116.

The leaves can include other voids to accommodate various structures on the respective part being enwrapped. For example, the leaf 105 enwrapping the housing can include a substantially cylindrical cutout 105a corresponding to the location of interconnecting cylindrical post of the valve stem. Each leaf can include an extended flap 117 to help enwrap its respective part. The flaps can include corresponding patches of hook and vane fabric fastener 118,119 or other fastening means described above to secure the enwrapping leaves. In this way, the shape and dimensioning of the buttes and voids can be selected to allow a substantially snug fitting of the panel to complex shapes while still retaining the advantage of having a substantially flatly and thus inexpensively manufactured insulating panel. In other words, the design is capable being adapted to allow each of the leaves to intimately wrap upon a geometrically simplified component of the complexly shaped fluid carrying structure.

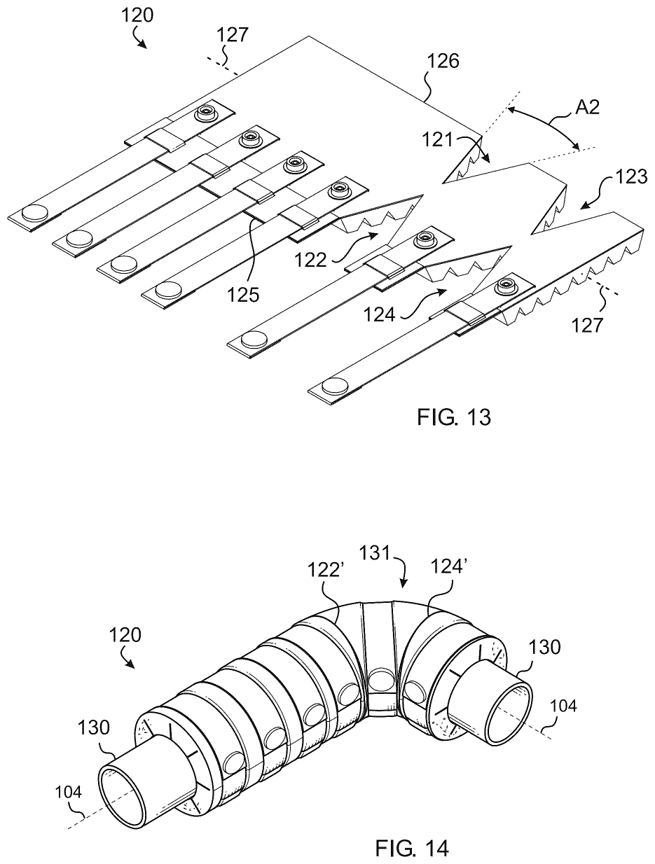

FIGS. 13-14 show that an insulator panel 120 can have a number of slits 121, 122,123, 124 extending laterally inwardly from the lateral side edges 125, 126 of the panel toward a medial central longitudinal axis 127. Each slit 121 for example can be substantially V-shaped having an angle A2 to allow for the panel to collapse around the bend of a curved conduit 130 having a curved central axis 104. In this embodiment there are two slits, each having an angle of about 45 allowing the panel to collapse upon a conduit having a bend of about 90. Once installed upon the conduit, the slits, 122 and 124 for example, can collapse to form gaps 122′, 124′ over the bending region 131 of the conduit. In this way, the slits allow a substantially flatly manufactured insulating panel to closely enwrap a curved conduit along its bend and the straight portions of the conduit adjacent to the bend.

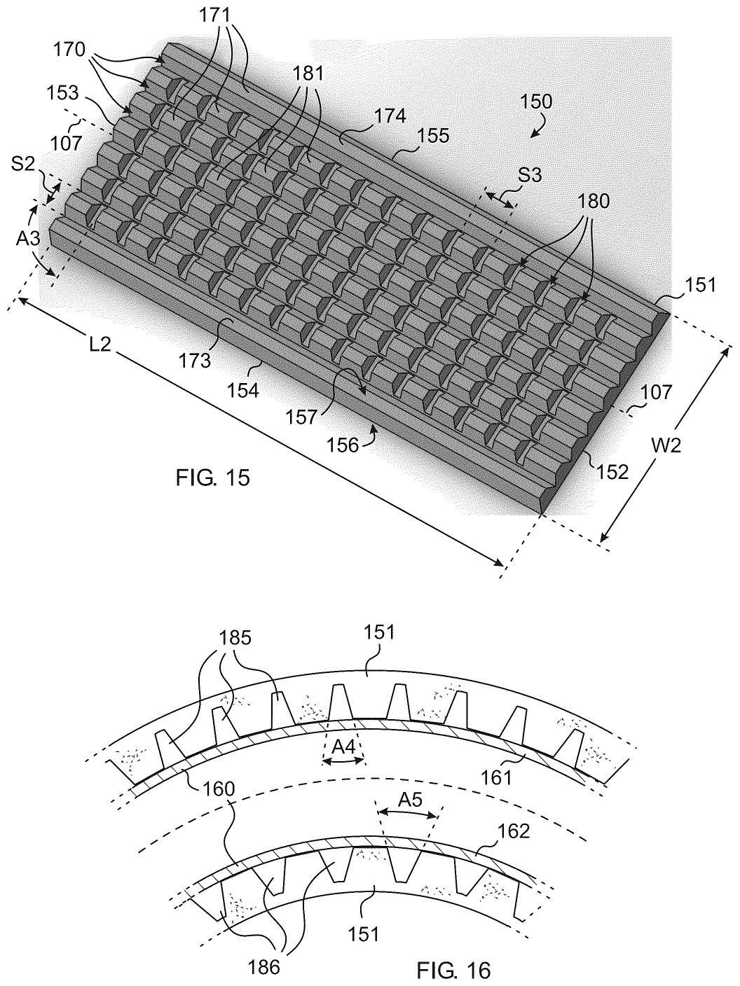

FIGS. 15-16 show an alternate embodiment of a device 150 used to insulate a typically stainless steel transmission line, pipe, or fluid conduit 160 which carries a fluid such as a heated gas to or from a microelectronic semiconductor reaction chamber.

The device 150 can include a panel 151 made of a flexible, resilient, insulating material. The panel 151 can have a generally, substantially quadrangular shape having a front edge 152 and a substantially parallel back edge 153 separated by a length L2 along a longitudinal elongation axis 107, and substantially parallel lateral side edges 154,155 separated by a width W2. The edges can surround a substantially planar bottom surface 156, hidden in FIG. 15, and an opposite fluted top surface 157.

In this embodiment the top surface 157 of the panel 151 can be formed to have seven substantially uniform and substantially wedge-shaped, longitudinally elongated reliefs, troughs or flutes 170 which can extend from the front edge 152 to the back edge 153, and similar to the embodiment of FIG. 1, can have a substantially V-shaped cross-section with their pointed ends oriented directly downward toward the bottom surface 156. The flutes can be substantially equidistantly laterally spaced apart by a spacing S2 to form eight longitudinally elongated, similarly spaced apart buttes 171, having substantially uniform cross-sections, therebetween.

In addition, the top surface 157 can be further formed to have a number longitudinally spaced apart latitudinal grooves 180 oriented at an angle A3 to the flutes. In this embodiment the grooves are oriented substantially orthogonally to the flutes and thus form an angle of about 90 to the flutes in order to wrap about a substantially planarly bent conduit as shown in FIG. 16. Alternately, for more complexly bent conduits, the grooves can form an angle with the flutes that is at least 10 degrees. In another example the grooves can form an angle with the flutes that is between about 10 and 150 degrees.

The grooves 180 can be spaced apart by a spacing S3. In this embodiment the grooves can have a substantially V-shaped cross-section but with a flattened lower tip rather than a pointed lower tip. The presence of the grooves make the buttes crenellated forming an array of substantially truncated pyramids 181. Thus the array of substantially truncated pyramids can be organized into rows and columns.

It is important to note that optionally the grooves 180 can terminate at the laterally peripheral buttes 173,174. In other words, the grooves extend through the medially located buttes but not the peripheral buttes. In this way the peripheral buttes provide an uninterrupted side edge surface to enhance bonding contact of the edges when the panel is completely wrapped around the conduit when installed.

As shown in FIG. 16, the installed insulating panel 151 can accommodate conduits having more than a slight bend. The grooves on the outwardly convex side 161 of the bend can compress to form cuts 185. In other words the sidewalls of the grooves can come closer together to form a more acute angle A4 with one another. On the outwardly concave side 162 of the bend the grooves can widen to form valleys 186. In other words the sidewalls of the grooves can spread farther apart to form a wider angle A5 with one another. This embodiment allows for conduit bends having a more complex geometry such as three-dimensional bends. The shape and spacing of the flutes, grooves, and buttes can be adjusted to accommodate individual complex geometry of the conduit being insulated.

In this way the insulator panel can be installed upon fluid conduits having more complex routing including bends and turns. Further, thicker insulation can be applied to smaller conduits. In this way the fluted insulator panel can avoid undue efficiency-robbing compression of foam material.

In this way, the weight of the overall panel can be reduced thereby reducing shipping costs and helping with manipulation during installation. This also reduces material usage costs and helps with long term environmental sustainability. Under this approach the panel can potentially provide an increased insulation value for a panel of a given thickness due to the sealed off cuts and valleys which can trap insulating ambient gasses such as air.

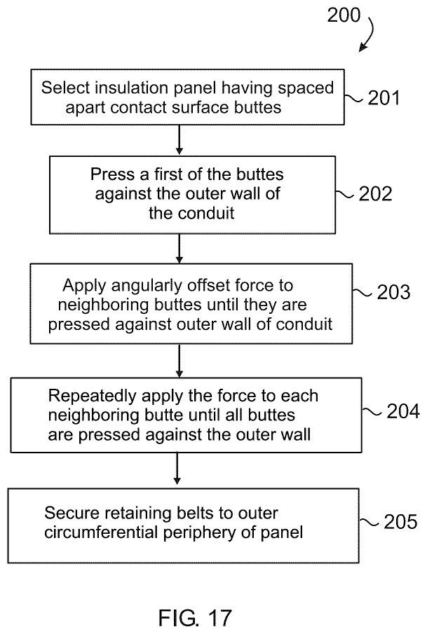

Referring now to FIG. 17 there is described a method 200 for insulating a fluid carrying structure such as an elongated cylindrical conduit. The method can include the steps of selecting 201 a substantially quadrangular oblong panel of flexible, resilient, insulating material having a plurality of parallelly spaced apart buttes extending upwardly toward a top surface. Then the panel can be oriented so that a capital surface of a first one of the buttes can be pressed 202 against an angular portion of the outer wall of the conduit. An angularly offset force can then be applied 203 to the neighboring buttes in order to bend the panel toward the conduit. Successively neighboring buttes can be similarly pressed 204 until the entire panel enwraps the conduit. Then the panel can be secured in its enwrapped configuration by engaging 205 fasteners on belts surrounding the outer circumferential periphery of the panel at spaced apart axial locations along the length of the panel, or engage other fastening means. It shall be understood that such a panel can be installed by applying a bending force that is selected based on the application parameters. However, by forming the voids on the inner surface of the panels the bending force required during installation in the above method can be reduced to less than 90% of the force required to bend a solid quadrangular panel of the same material. In some applications the bending force required during installation can be reduced to between about 30% and 90% of the force required to bend a solid quadrangular panel of the same material.

### Example 1

In this way, a 3D printed mold for creating the insulator shown above can be designed in about 2 hours, have a mold cost of about $500, and take about 3 days to complete. And significantly, a machined mold for a greater lifespan and/or insulators of greater size can be manufactured having a design time of about 6 hours, cost about $1200, and take about 3 weeks to complete.

The above approach can also allow for the manufacture of insulators to an exact size, or to produce master lengths that can be cut as needed depending on the application.

For most applications involving substantially cylindrical conduits having a range of outside diameters of between about 6 mm and about 100 mm and carrying fluid which does not exceed 200 degrees C., the insulating panel can be selected from readily available materials such as silicone foam rubber, silicone gum rubber, extruded silicone, extruded silicone foam, and, fiberglass, and have length of between about 30 cm and 100 cm, a width of between about 20 mm and 30 cm, and a largest thickness of between about 2 mm and 5 cm.

### Example 2

The following is a structural example of the materials and thicknesses of the various features of the insulator panel.

An amount of 3-8209 brand silicone foam commercially available from Dow Corning of Midland, Michigan, is selected having a 1:1 mix ratio and the ability to be molded as needed. The molded panel is shaped so that its top surface has eleven parallelly spaced apart V-shaped grooves thereby forming 12 parallelly spaced apart buttes extending upwardly. The back surface is substantially planar.

A length of a cylindrical steel fluid conduit having a uniform outer diameter of about 50 mm is selected to carry a fluid at about 200 degrees C.

The laterally middle part of the top surface of the panel is pressed against the conduit with the panel's elongation axis parallel with the central axis of the conduit. A minimal force of is applied to the bottom surface of the panel straddling the middle part, causing the panel to bend laterally toward the conduit. The force is applied successively an increasing lateral distance from the middle part until the panel is wrapped completely around the length of conduit. The force was between about 30% and 90% of the force required to bend a solid quadrangular panel of the same material. A number of belts are secured around the circumferential periphery of the panel to maintain it being wrapped about the conduit.

While the preferred embodiment of the invention has been described, modifications can be made and other embodiments may be devised without departing from the spirit of the invention and the scope of the appended claims.

What is claimed is:

1. A device for insulating a fluid conduit having a substantially cylindrical outer wall section of a given radius, said device comprises:
a panel of flexible, resilient, insulating material;
said panel comprises:
a top surface;
a bottom surface;
said panel being elongated between a front edge and a back edge along an axis; and,
a plurality of voids extending into said top surface;
wherein each of said voids extends between said front edge and said back edge.

2. The device of claim 1, wherein said voids comprise:
laterally spaced apart flutes formed into said top surface, thereby forming a number of upwardly extending buttes spaced apart by a spacing.

3. The device of claim 2, wherein each of said flutes extends substantially linearly between said front edge and said back edge.

4. The device of claim 2, which further comprises a gap between an adjacent pair of said buttes, wherein said gap is between 0% and 70% of a cross-sectional width a first one of said adjacent pair of said buttes.

5. The device of claim 2, wherein each of said flutes is substantially wedge-shaped and oriented so that a widened part exists along said top surface; and, wherein each of said flutes has a substantially uniform cross-section between said front and back edges.

6. The device of claim 2, wherein each of said buttes has a substantially trapezoidal cross-section having a substantially symmetrical pair of laterally angled, substantially planar flanks; wherein an adjacent pair of said buttes provide a pair of opposed flanks bordering one of said flutes; and wherein said flanks form a first angle; and, wherein said number of buttes equals 360 divided by said first angle in degrees.

7. The device of claim 6, wherein a first one of said buttes comprises:
an upper surface section having a substantially semi-cylindrical shape extending along an angular arc of not more than said first angle; and,
wherein said device further comprises:
a fluid conduit having a substantially cylindrical outer surface section of a given radius;
wherein said arcuate upper surface section has a preformed radius commensurate with said given radius.

8. The device of claim 1, wherein said panel further comprises:
a pair of spaced apart side edges;
a first slit extending medially from a first one of said side edges; and,
wherein said slit is substantially V-shaped when viewed from above.

9. The device of claim 2, wherein said the top surface can be formed to have a number longitudinally spaced apart grooves oriented at an angle to said flutes, wherein said grooves are longitudinally spaced apart by a second spacing.

10. The device of claim 9, wherein said grooves form an angle with said flutes of between 10 and 150 degrees.

11. The device of claim 2, wherein each of said buttes is crenellated to have an array of substantially truncated pyramids.

12. The device of claim 2, wherein said device further comprises at least one heater element connected to said panel.

13. The device of claim 1, wherein said flexible, resilient, insulating material is selected from the group consisting of:
silicone foam rubber; silicone gum rubber; extruded silicone; extruded silicone foam; moldable foam materials; moldable insulative materials; and, fiberglass.

14. The device of claim 1, which further comprises a layer of interface material formed on a section of said top surface; wherein said layer of interface material has a higher heat tolerance than said insulating material.

15. The device of claim 1, wherein said flexible, resilient, insulating material cannot withstand temperatures exceeding 300° C.; and, wherein said flexible, resilient, insulating material has a density of between about 200 kg/m3 and about 280 kg/m3.

16. The device of claim 1, wherein said panel further comprises:
a plurality of leaves;
wherein each of said leaves is shaped and dimensioned to intimately wrap upon a geometrically simplified component of a complexly shaped fluid carrying structure; and,
wherein each of said plurality of leaves has a common bending axis.

17. The device of claim 1, wherein said voids form a structure for reducing a bending moment substantially perpendicular to said axis.

18. The device of claim 1, which further comprises:
a backing sheet made from a pliable material; and,
a bonding layer securing each of said buttes to said backing sheet.

19. The device of claim 18, wherein said backing sheet comprises:
a series of rows joined by hinges.

20. The device of claim 1, which further comprises:
a blanket made from a durable, pliable sheet material secured to said bottom surface of said panel;
a retaining structure secured to said blanket;
whereby said retaining structure retains said panel in an enwrapped configuration about said conduit; and,
wherein said retaining structure comprises:
a plurality of belts slidingly mounted to said blanket; and,
a plurality of fasteners for securing said belts in a fixed circumference.
